(19) United States
(12) Patent Application Publication
(10) Pub. No.: US 2013/0004879 A1
(43) Pub. Date: Jan. 3, 2013

(54) FUEL CELL SYSTEM

(75) Inventors: Takeshi OHTANI, Wako (JP); Akihiro SUZUKI, Wako (JP)

(73) Assignee: HONDA MOTOR CO., LTD., Tokyo (JP)

(21) Appl. No.: 13/535,295

(22) Filed: Jun. 27, 2012

(30) Foreign Application Priority Data
Jun. 30, 2011 (JP) 2011-145112

(51) Int. Cl. H01M 8/04

(52) U.S. Cl. 429/443

(57) ABSTRACT

A fuel cell system includes a fuel cell device, a fuel supply device, and a control device. The fuel cell device includes a fuel cell, a fuel-cell related auxiliary machine, and a fuel-cell related information sensor. The fuel supply device includes a fuel source for the fuel cell, a fuel-source related auxiliary machine, and a fuel-source related information sensor. The control device is configured to control the fuel cell device and the fuel supply device, and is configured to process information provided from the fuel-cell related information sensor and the fuel-source related information sensor. The control device includes a first controller provided in the fuel cell device, and a second controller provided in the fuel supply device.

### CROSS-REFERENCE TO RELATED APPLICATIONS

The present application claims priority under 35 U.S.C. §119 to Japanese Patent Application No. 2011-145112, filed Jun. 30, 2011, entitled “Fuel Cell System.” The contents of this application are incorporated herein by reference in their entirety.

### BACKGROUND OF THE INVENTION

1. Field of the Invention

The disclosure relates to a fuel cell system.

2. Discussion of the Background

Japanese Unexamined Patent Application Publication (Translation of PCT Application) No. 2009-506482 discloses a fuel cell system that electrically and mechanically connects a fuel cell unit including a fuel cell, a control unit, various sensors, a storage device and a pump, and a fuel supply unit including a fuel source, various sensors and an auxiliary machine such as a valve.

FIG. 5 presents a configurational view when a fuel cell system fundamentally having such a configuration is mounted in a fuel cell vehicle. FIG. 5 also shows a fueling station for supplying fuel to the fuel supply unit.

A fuel cell unit 50 includes a fuel cell stack 51, an auxiliary machine 52 such as a shut-off valve and a regulator, which supplies and stops fuel to the fuel cell stack 51, various sensors 53 needed for operational control of the fuel cell stack 51, an information storage unit 54 that stores data detected by the various sensors 53, or the like, and a controller 55 that controls, for example, the auxiliary machine 52 based on data input from the information storage unit 54.

A fuel supply unit 60 includes a fuel tank 61 storing fuel, an auxiliary machine 62 such as a shut-off valve, which is provided at the outlet of fuel tank 61, and various sensors 63 such as a pressure sensor for detecting pressure in the fuel tank.

### SUMMARY OF THE INVENTION

According to one aspect of the present invention, a fuel cell system includes a fuel cell device, a fuel supply device, and a control device. The fuel cell device includes a fuel cell, a fuel-cell related auxiliary machine, and a fuel-cell related information sensor. The fuel supply device includes a fuel source for the fuel cell, a fuel-source related auxiliary machine, and a fuel-source related information sensor. The control device is configured to control the fuel cell device and the fuel supply device, and is configured to process information provided from the fuel-cell related information sensor and the fuel-source related information sensor. The control device includes a first controller provided in the fuel cell device, and a second controller provided in the fuel supply device.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is an exemplary diagram showing a fuel cell vehicle on which a fuel cell system according to the disclosure is mounted from a side.

FIG. 2 is a block diagram showing the schematic configuration of the fuel cell system and the schematic configuration of a fueling station.

FIG. 3 is a rear view showing a fuel cell unit in the fuel cell system from the rear of the vehicle.

FIG. 4 is a rear view showing the fuel cell unit in the fuel cell system from above.

FIG. 5 is a block diagram showing the schematic configurations of a fuel cell system and a fueling station according to related art.

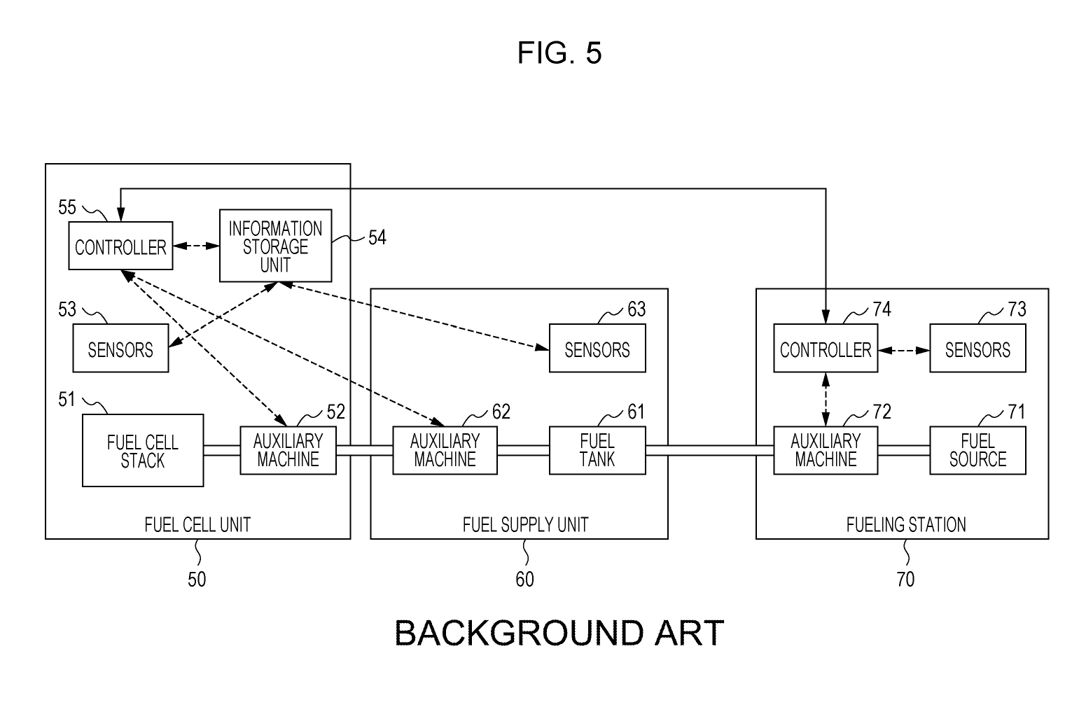

### DESCRIPTION OF THE EMBODIMENTS

The embodiments will now be described with reference to the accompanying drawings, wherein like reference numerals designate corresponding or identical elements throughout the various drawings.

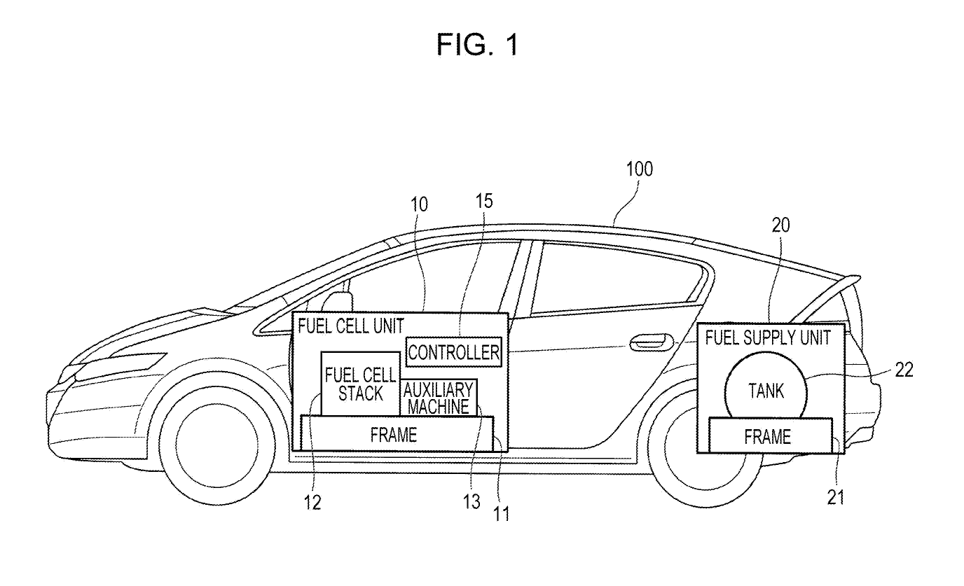

A fuel cell system according to an embodiment of the disclosure will be described below with reference to FIGS. 1 to 4.

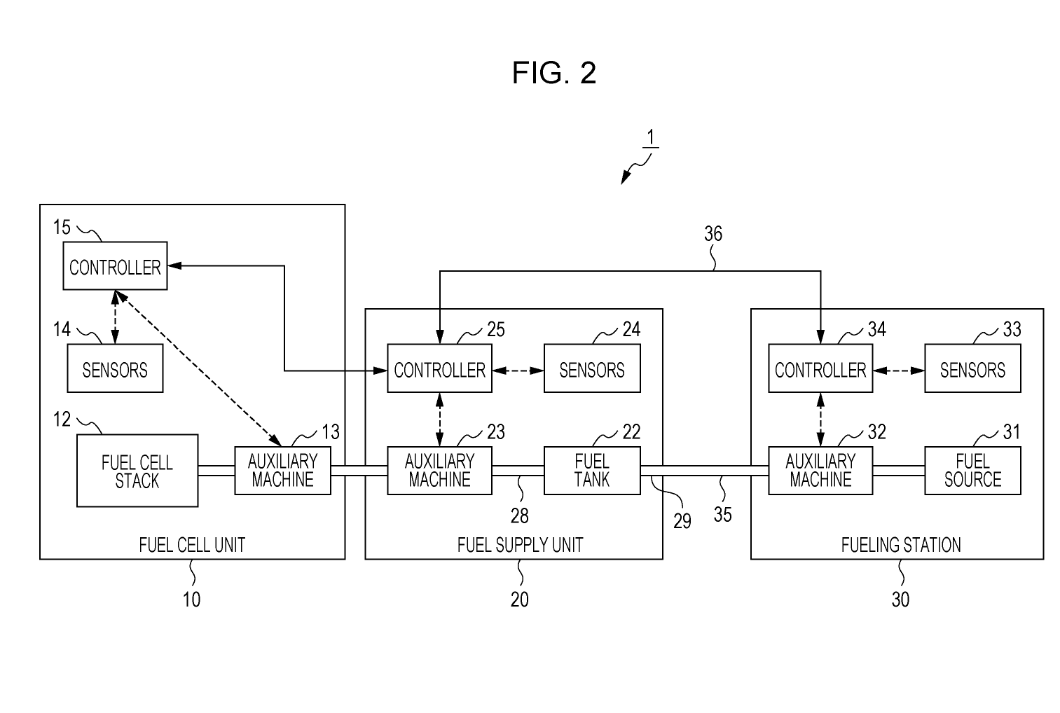

FIG. 1 is an exemplary diagram showing a fuel cell vehicle 100 on which a fuel cell system 1 according to the disclosure is mounted from a side, and FIG. 2 is a block diagram showing the schematic configuration of the fuel cell system 1 and the schematic configuration of a fueling station 30.

The fuel cell system 1 includes a fuel cell unit (fuel cell device) 10, and a fuel supply unit (fuel supply device) 20. As shown in FIG. 1, the fuel cell unit 10 is mounted in the front portion of the vehicle 100, and the fuel supply unit 20 is mounted in the rear portion of the vehicle 100. More specifically, the fuel cell unit 10 is mounted under the front seat of the vehicle 100, and the fuel supply unit 20 is mounted rearward of the rear seat of the vehicle 100. That is, the fuel cell unit 10 and the fuel supply unit 20 are arranged apart from each other in the fore-and-aft direction of the vehicle 100. The fuel cell unit 10 and the fuel supply unit 20 are mechanical connected together by fuel piping. A controller 15 and a controller 25 (FIG. 2) are connected together by an electric wire.

As shown in FIG. 2, the fuel cell unit 10 includes a fuel cell stack 12, an auxiliary machine (fuel-cell related auxiliary machine) 13 needed to operate the fuel cell stack 12, various sensors (fuel-cell related information sensors) 14 needed to manage the operation of the fuel cell stack 12, and the controller (first controller) 15 for controlling the operation of the fuel cell stack 12. The fuel cell unit 10 is supported on a frame 11 (FIG. 1).

The auxiliary machine 13 of the fuel cell unit 10 includes, for example, a humidifier, a compressor that supplies an oxidizer to the fuel cell stack 12, a shut-off valve that can stop the supply of fuel to the fuel cell stack 12, and a regulator that reduces the pressure of the fuel to be supplied from the fuel supply unit 20 to a predetermined pressure. The auxiliary machine 13 is controlled by the controller 15.

The sensors 14 of the fuel cell unit 10 include, for example, a stack temperature sensor that detects the temperature of the fuel cell stack 12, and a cathode pressure sensor that detects the pressure of a cathode-off gas exhausted from the fuel cell stack 12. The sensors 14 output electric signals corresponding to detection values to the controller 15.

The controller 15 of the fuel cell unit 10 includes a memory section that stores information input from the sensors 14, and a control circuit that controls, for example, the auxiliary machine 13 based on the information stored in the memory section.

The fuel supply unit 20 includes a fuel tank 22, an auxiliary machine (fuel-source related auxiliary machine) 23 needed to discharge fuel from the fuel tank 22 and supply fuel into the fuel tank 22, various sensors (fuel-source related information sensors) 24 that detects information needed to manage the operation of the auxiliary machine 23, and the controller (second controller) 25 for controlling the operation of the auxiliary machine 23. The fuel supply unit 20 is supported on a frame 21 (FIG. 1).

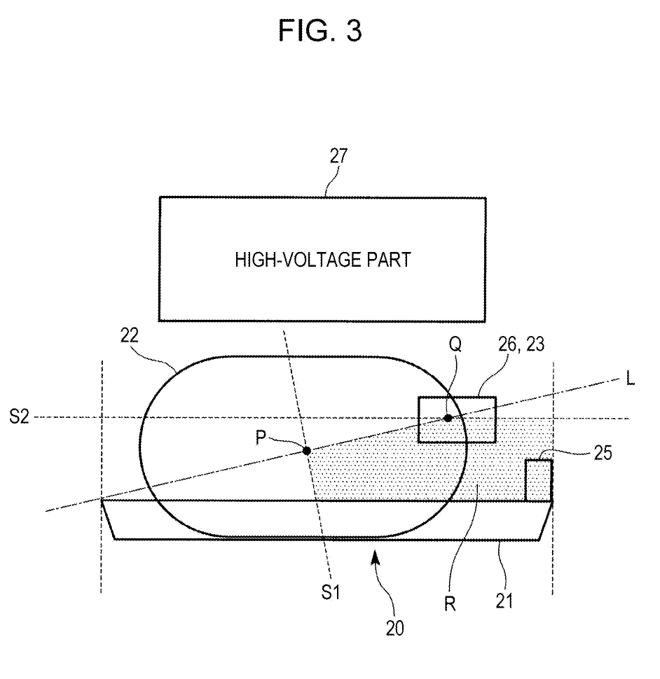

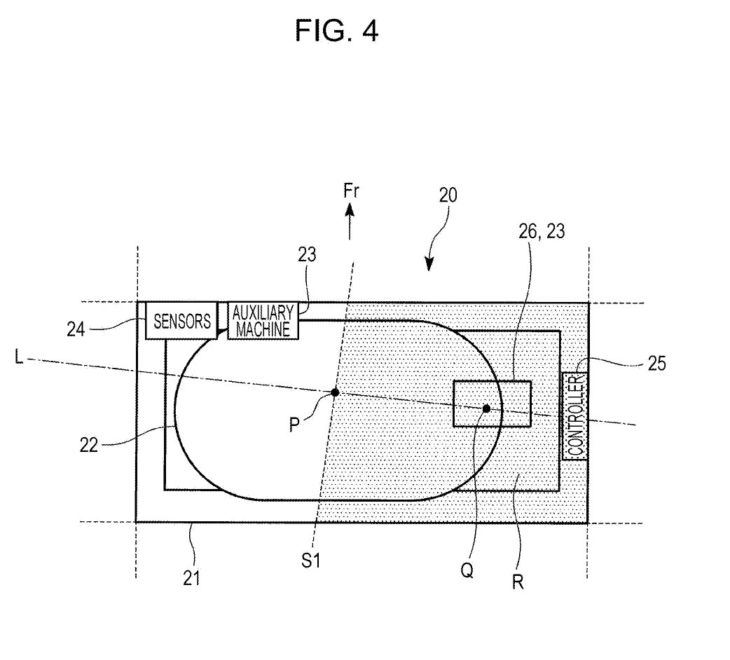

As shown in FIGS. 3 and 4, the fuel tank 22 includes a main stop valve 26 disposed at the outlet portion of the fuel tank 22. The main stop valve 26 selectively connects or disconnects the interior of the fuel tank 22 to or from a fuel supply passage 28 or fueling passage 29 shown in FIG. 2, and includes an electromagnetic driving section. Therefore, the main stop valve 26 also is an auxiliary machine for fueling. Though not illustrated, the main stop valve 26 includes a tank pressure sensor that detects a pressure inside the fuel tank 22, and a tank temperature sensor that detects a temperature inside the fuel tank 22.

The auxiliary machine 23 of the fuel supply unit 20 includes the main stop valve 26, and a regulator that reduces the fuel pressure discharged from the main stop valve 26 in addition thereto. The auxiliary machine 23 (including the electromagnetic driving section of the main stop valve 26) is controlled by the controller 25.

The sensors 24 of the fuel supply unit 20 include the aforementioned tank pressure sensor and tank temperature sensor provided at the main stop valve 26, and additionally include a hydrogen sensor that detects the hydrogen concentration around the fuel tank 22. The sensors 24 output electric signals corresponding to detection values to the controller 25.

The controller 25 of the fuel supply unit 20 includes a memory section that stores information input from the sensors 24, and a control circuit that controls, for example, the auxiliary machine 23 based on the information stored in the memory section.

Referring to FIGS. 3 and 4, the layout of the fuel supply unit 20 will be described in detail. Reference symbol “Fr” in FIG. 4 indicates the frontward of the vehicle.

The frame 21 has a rectangular frame shape with an open center portion elongated in the widthwise direction of the vehicle 100 in a plan view. The fuel tank 22 is mounted on the frame 21. The fuel tank 22 has a hemispherical cylindrical shape elongated in the widthwise direction of the vehicle 100, and is located substantially in the center in the fore-and-aft direction of the frame 21 and slightly leftward in the horizontal direction. The main stop valve 26 is provided on the right end of the fuel tank 22 in FIGS. 3 and 4.

A high-voltage part (e.g., high-voltage battery) 27 as an electromagnetic noise generating section is disposed directly above the fuel tank 22.

As shown in FIGS. 3 and 4, the center of the fuel supply unit 20 excluding the controller 25 is P, and the center of the main stop valve 26 is Q.

The center P of the fuel supply unit 20 is the center of gravity (centroid) that is defined by individual components excluding the piping and wiring, given that the densities of the individual components are constant.

A plane which has a line L passing through the center P of the fuel supply unit 20 and the center Q of the main stop valve 26 as a normal line, and passes through the center P of the fuel supply unit 20 is set as a first reference plane S1.

Further, a plane which is in parallel to the boundary plane between the high-voltage part 27 and the fuel supply unit 20, and passes through the center Q of the main stop valve 26 is set as a second reference plane S2. According to the embodiment, the second reference plane S2 is a horizontal plane passing through the center Q of the main stop valve 26.

When the reference planes S1, S2 are set this way, it is preferable to arrange the controller 25 of the fuel supply unit 20 in space closer to the main stop valve 26 than the first reference plane S1 for the following reason. As mentioned above, the main stop valve 26 includes the tank pressure sensor and the tank temperature sensor besides the electromagnetic driving section for switching the passage, and needs a lot of electric wires to be connected to the controller 25. If the controller 25 is disposed in the space closer to the main stop valve 26 than the first reference plane S1, the distance between the controller 25 and the main stop valve 26 can be made relatively short as compared to the case where the controller 25 is disposed in space farther from the main stop valve 26 than the first reference plane S1, thus making it possible to shorten the lengths of the electric wires.

It is also preferable to dispose the controller 25 in space farther from the high-voltage part 27 with respect to the second reference plane S2. This arrangement ensures that the controller 25 and the electric wires to be connected thereto are not easily affected by electromagnetic noise generated from the high-voltage part 27, thus improving noise immunity.

Further, it is preferable to dispose the controller 25 inward of the outermost periphery (outermost portion) of the frame 21 in a plan view. This arrangement ensures that the controller 25 is not easily broken when there is an impact on the vehicle.

In FIGS. 3 and 4, a dotted region R indicates a region above the frame 21 where the foregoing three conditions are fulfilled.

It is preferable that the controller 25 should be directly mounted on the frame 21 because the controller 25 can be provided securely.

In case of directly mounting the controller 25 at the frame 21, it is preferable to mount the controller 25 on the frame 21. This is because the arrangement can protect the controller 25 and the electric wires against chipping (of a stone), splashing (of water) or the like.

It is preferable that the controller 25 of the fuel supply unit 20 should include a crash detection circuit. This configuration improves the reliability of shutting off fuel supply when the vehicle 100 crashes.

According to the embodiment, as shown in FIGS. 3 and 4, the controller 25 is directly mounted on the frame 21 at a position closest to the main stop valve 26. As shown in FIG. 4, the auxiliary machine 23 (regulator or the like) other than the main stop valve 26, and the sensors 24 (hydrogen sensor or the like) other than the sensors provided at the main stop valve 26 are disposed above the front portion of the frame 21.

According to the fuel cell system 1 with the foregoing configuration, the fuel cell unit 10 includes the controller 15 necessary for the internal control of the fuel cell unit 10, and the fuel supply unit 20 includes the controller 25 necessary for the internal control of the fuel supply unit 20, so that number of electric wires connecting between the fuel cell unit 10 and the fuel supply unit 20 can be reduced as compared to the case of the fuel cell system according to the related art whose fuel supply unit does not include a controller. As a result, the weight of the overall electric wires can be reduced, and the cost can be reduced accordingly. In addition, the layout of a vehicle has a higher degree of freedom, thus improving the merchantability.

Because the sensors 24 can be connected to the controller 25 in the fuel supply unit 20, the lengths of the electric wires can be shortened as compared to the case of the fuel cell system according to the related art whose fuel supply unit does not include a controller, so that the electric wires are not easily affected by electromagnetic noise.

Further, in changing the specifications of devices provided in the fuel supply unit 20, there would be increased cases of completing replacement of parts inside the fuel supply unit 20, thus resulting in improved serviceability.

To permit communication fueling at the time of supplying fuel into the fuel tank 22 at the fueling station 30, the controller 25 of the fuel supply unit 20 should preferably include a communication sensor for communication with the fueling station 30 (e.g., sensor or the like to check the connection of the fuel filling port of the vehicle 100 and fuel filling hose 35), and a circuit (hereinafter referred to as “circuit for fueling”) for using and controlling the auxiliary machine for fueling (main stop valve 26 or the like).

When the controller 25 of the fuel supply unit 20 includes the circuit for fueling, it is sufficient to active the controller 25 of the fuel supply unit 20 alone at the time of carrying out communication fueling between the fueling station and the fuel cell system, and activation of the controller 15 of the fuel cell unit 10 is unnecessary. As a result, the sensors 14 and the auxiliary machine 13 which are connected to the controller 15 of the fuel cell unit 10 need not be activated, making it possible to suppress dissipation power.

As shown in FIG. 2, the fueling station 30 includes a fuel source 31 storing fuel, an auxiliary machine 32 such as a shut-off valve provided at the outlet of the fuel source 31, various sensors 33 such as a pressure sensor for detecting the internal pressure of the fuel source 31, and a controller 34 that controls the auxiliary machine 32.

Communication fueling of fuel is carried out with the fuel filling hose 35 extending from the auxiliary machine 32 of the fueling station 30 being connected to the fuel filling port (not shown) of the vehicle 100, and with the controller 34 of the fueling station 30 being electrically connected to the controller 25 of the fuel supply unit 20.

In this case, it is necessary to provide the vehicle 100 with a connecting section (hereinafter referred to as “communication connecting section”) to which a communication-fueling communication line 36 extending from the controller 34 of the fueling station 30 is connected. It is preferable that the communication connecting section should be provided on an outer surface of the vehicle 100 at a view point where the main stop valve 26 comes closest to the outer surface of the vehicle 100 (body outer surface) among individual viewpoints in the fore-and-aft direction, the horizontal direction and vertical direction of the vehicle 100. This arrangement can permit the communication connecting section to be located close to the main stop valve 26, resulting in that the communication connecting section and the controller 25 of the fuel supply unit 20 can be arranged close to each other. This can shorten the lengths of the electric wires that connect the communication connecting section to the controller 25, thus ensuring that the electric wires are not easily affected by electromagnetic noise.

Further, the controller 25 of the fuel supply unit 20 may be provided with a circuit for fueling, and the controller 15 of the fuel cell unit 10 may be provided with a communication sensor for communication with the fueling station 30, and a circuit for fueling for using and controlling the auxiliary machine for fueling.

This configuration can permit redundancy of the circuit for fueling to be achieved, so that when the circuit for fueling in the controller 25 of the fuel supply unit 20 fails, the circuit for fueling in the controller 15 of the fuel cell unit 10 can be used to carry out fueling. This reduces the probability that fueling cannot be carried out.

According to one aspect of an exemplary embodiment of the disclosure, there is provided a fuel cell system (e.g., the fuel cell system 1 according to the embodiment) including a fuel cell device (e.g., the fuel cell unit 10 according to the embodiment) having a fuel cell (e.g., the fuel cell stack 12 according to the embodiment), a fuel-cell related auxiliary machine (e.g., the auxiliary machine 13 according to the embodiment), and a fuel-cell related information sensor (e.g., the sensors 14 according to the embodiment); a fuel supply device (e.g., the fuel supply unit 20 according to the embodiment) having a fuel source (e.g., the fuel tank 22 according to the embodiment) for the fuel cell, a fuel-source related auxiliary machine (e.g., the auxiliary machine 23 according to the embodiment), and a fuel-source related information sensor (e.g., the sensors 24 according to the embodiment); and a control device that controls the fuel cell device and the fuel supply device, and handles information input from the individual sensors, the control device including a first control unit (e.g., the controller 15 according to the embodiment) provided in the fuel cell device, and a second control unit (e.g., the controller 25 according to the embodiment) provided in the fuel supply device.

According to the foregoing fuel cell system, the fuel cell device includes the first control unit, and the fuel supply device includes the second control unit, so that the number of electric wires connecting between the fuel cell device and the fuel supply device can be reduced, thereby decreasing the weight and the cost of the fuel cell system. In addition, the lengths of the electric wires in the fuel supply device can be shortened, so that the electric wires are not easily susceptible to electromagnetic noise.

Further, in changing the specifications of devices provided in the fuel supply device, there would be increased cases of completing replacement of parts inside the fuel supply device, thus resulting in improved serviceability.

In the fuel cell system according to the one aspect of the embodiment, the second control unit may include a circuit for using the fuel-source related auxiliary machine and the fuel-source related information sensor.

According to the above fuel cell system, the fuel-source related auxiliary machine can be controlled by the second control unit.

In the fuel cell system according to the one aspect of the embodiment, the fuel supply device may include an auxiliary machine for fueling (e.g., the main stop valve 26 according to the embodiment), and the second control unit may include a communication sensor for communication with a fueling station (e.g., the fueling station 30 according to the embodiment) located outside the fuel cell system, and a circuit for using the auxiliary machine for fueling.

According to this fuel cell system, in case of executing fueling while carrying out communication between the fueling station and the fuel cell system, it is sufficient to active the second control unit alone, and activation of the first control unit is unnecessary, so that dissipation power can be suppressed.

In this fuel cell system, the first control unit, together with the second control unit, may include the communication sensor, and the circuit for using the auxiliary machine for fueling.

According to this fuel cell system, redundancy of the circuit for fueling can be achieved, so that when the circuit for fueling in the second control unit of the fuel supply device fails, the circuit for fueling in the first control unit of the fuel cell device can be used to carry out fueling.

In the fuel cell system according to the one aspect of the embodiment, the fuel cell system may be mounted in a vehicle (e.g., the vehicle 100 according to the embodiment), and the second control unit may include a crash detection circuit.

This fuel cell system improves the reliability of shutting off fuel supply when a vehicle crashes.

In the fuel cell system according to the one aspect of the embodiment, the fuel cell system may be mounted in a vehicle (e.g., the vehicle 100 according to the embodiment), the fuel source may be a fuel tank (e.g., the fuel tank 22 according to the embodiment), having a main stop valve (e.g., the main stop valve 26 according to the embodiment), and provided that of planes having a line passing through a center of the fuel supply device excluding the second control unit and a center of the main stop valve as a normal line, a plane passing through the center of the fuel supply device is set as a first reference plane, the second control unit may be disposed in a space closer to the main stop valve and obtained by dividing a space in the fuel supply device by the first reference plane.

According to this fuel cell system, the distance between the second control unit of the fuel supply device and the main stop valve of the fuel tank can be made relatively shorter, so that the length of the electric wire connecting the second control unit and the main stop valve can be shortened.

In this fuel cell system, the fuel supply device may include an auxiliary machine for fueling (e.g., the main stop valve 26 according to the embodiment), the second control unit may include a communication sensor for communication with a fueling station (e.g., the fueling station 30 according to the embodiment) located outside the fuel cell system, and a circuit for using the auxiliary machine for fueling, and a communication connecting section enabling communication with the fueling station, the communication connecting section being provided on a vehicle's outer surface closest to the main stop valve among a plurality of outer surfaces of the vehicle arranged around the fuel supply device.

According to this fuel cell system, the communication connecting section can be disposed at a position close to the main stop valve, resulting in close arrangement of the communication connecting section and the second control unit of the fuel supply device. Accordingly, the length of the electric wire connecting the communication connecting section and the second control unit can be shortened, thus ensuring that the electric wires are not easily susceptible to electromagnetic noise.

In this fuel cell system, the second control unit may be provided at a frame (e.g., the frame 21 according to the embodiment) supporting the fuel supply device.

According to this fuel cell system, the second control unit can be provided securely.

In this fuel cell system, given that a direction toward outside the vehicle is set as outward, and a direction toward inside the vehicle is set as inward, the second control unit may be provided inward of an outermost portion of the frame.

According to this fuel cell system, the second control unit can be made strong enough not to be easily broken when there is an impact on the vehicle.

In this fuel cell system, the second control unit may be mounted on the frame.

According to this fuel cell system, the second control unit and the electric wires can be protected against chipping (of a stone), splashing (of water) or the like.

In this fuel cell system, provided that a plane provided in parallel to a boundary plane between an electromagnetic noise generating section (e.g., the high-voltage part 27 according to the embodiment) closest to the main stop valve and the fuel supply device, and passing through the center of the main stop valve is set as a second reference plane, the second control unit may be disposed in a space farthest from the electromagnetic noise generating section and obtained by dividing the space in the fuel supply device by the second reference plane.

According to this fuel cell system, it is possible to prevent the second control unit and the electric wires connected thereto from being easily affected by electromagnetic noise generated from the electromagnetic noise generating section, thus improving noise immunity.

Obviously, numerous modifications and variations of the present invention are possible in light of the above teachings. It is therefore to be understood that within the scope of the appended claims, the invention may be practiced otherwise than as specifically described herein.

What is claimed is:

1. A fuel cell system comprising:
a fuel cell device comprising:
a fuel cell;
a fuel-cell related auxiliary machine; and
a fuel-cell related information sensor;
a fuel supply device comprising:
a fuel source for the fuel cell;
a fuel-source related auxiliary machine; and
a fuel-source related information sensor; and
a control device configured to control the fuel cell device and the fuel supply device and configured to process information provided from the fuel-cell related information sensor and the fuel-source related information sensor, the control device comprising:
a first controller provided in the fuel cell device; and
a second controller provided in the fuel supply device.

2. The fuel cell system according to claim 1, wherein the second controller includes a circuit configured to control the fuel-source related auxiliary machine and the fuel-source related information sensor.

3. The fuel cell system according to claim 1,
wherein the fuel supply device includes a fueling auxiliary machine, and
wherein the second controller includes a communication sensor configured to communicate with a fueling station located outside the fuel cell system, and a circuit configured to control the fueling auxiliary machine.

4. The fuel cell system according to claim 3, wherein the first controller, together with the second controller, includes the communication sensor, and the circuit configured to control the fueling auxiliary machine.

5. The fuel cell system according to claim 1,
wherein the fuel cell system is mounted in a vehicle, and
wherein the second controller includes a crash detection circuit.

6. The fuel cell system according to claim 1,
wherein the fuel cell system is mounted in a vehicle,
wherein the fuel source includes a fuel tank,
wherein the fuel-source related auxiliary machine includes a stop valve, and
wherein the second controller is disposed in a space closer to the stop valve and obtained by dividing a space defined in the fuel supply device by a first reference plane passing through a center of the fuel supply device excluding the second controller, the first reference plane being perpendicular to a line passing through the center of the fuel supply device and a center of the stop valve.

7. The fuel cell system according to claim 6,
wherein the fuel supply device includes a fueling auxiliary machine,
wherein the second controller includes a communication sensor configured to communicate with a fueling station located outside the fuel cell system, and a circuit configured to control the fueling auxiliary machine, and
wherein a communication connecting device configured to enable communication with the fueling station, the communication connecting device being provided on an outer surface of the vehicle closest to the stop valve among a plurality of outer surfaces of the vehicle which are arranged around the fuel supply device.

8. The fuel cell system according to claim 6, further comprising:
a frame supporting the fuel supply device,
wherein the second controller is provided at the frame.

9. The fuel cell system according to claim 8, wherein given that a direction toward outside the vehicle is defined as outward, and a direction toward inside the vehicle is defined as inward, the second controller is provided inward of an outermost portion of the frame.

10. The fuel cell system according to claim 8, wherein the second controller is mounted on the frame.

11. The fuel cell system according to claim 8, wherein the second controller is disposed in a space farthest from an electromagnetic noise generator and obtained by dividing the space defined in the fuel supply device by a second reference plane passing through the center of the stop valve, the second reference plane being provided in parallel to a boundary plane between the fuel supply device and the electromagnetic noise generator closest to the stop valve.

12. The fuel cell system according to claim 8, wherein the second controller is disposed farther from an electromagnetic noise generator than the stop valve.

13. The fuel cell system according to claim 1,
wherein the fuel cell system is mounted in a vehicle,
wherein the fuel source includes a fuel tank,
wherein the fuel-source related auxiliary machine includes a stop valve, and
wherein the second controller is disposed farther from the fuel tank than the stop valve.

14. The fuel cell system according to claim 1, wherein the fuel-cell related auxiliary machine includes at least one of
a humidifier,
a compressor to supply an oxidizer to the fuel cell,
a shut-off valve to stop supply of fuel to the fuel cell, and
a regulator to reduce pressure of fuel to be supplied from the fuel supply device to a predetermined pressure.

15. The fuel cell system according to claim 1,
wherein the first controller is configured to handle information input from the fuel-cell related information sensor, and
wherein the second controller is configured to handle information input from the fuel-source related information sensor.
